(19) United States
(12) Patent Application Publication
(10) Pub. No.: US 2015/0348068 A1
(43) Pub. Date: Dec. 3, 2015

(54) PREDICTING WAITING PASSENGER COUNT AND EVALUATION

(71) Applicant: INTERNATIONAL BUSINESS MACHINES CORPORATION, Armonk, NY (US)

(72) Inventors: Xiang Fei, Beijing (CN); Min Gong, Shanghai (CN); Yun Jie Qiu, Shanghai (CN); Zhi Hu Wang, Beijing (CN); Junchi Yan, Shanghai (CN)

(21) Appl. No.: 14/722,879

(22) Filed: May 27, 2015

(30) Foreign Application Priority Data
May 28, 2014 (CN) 201410229206.1

(51) Int. Cl. G06Q 30/02; G06Q 10/06

(52) U.S. Cl. CPC G06Q 30/0202; G06Q 10/06393

(57) ABSTRACT

Predicting waiting passenger count and evaluation. The present invention provides to a dispatching support system in order to help bus dispatchers or operators make better instructions or decisions, by providing short-term passenger flow prediction. The dispatcher finds the predicted passenger flow and obtains accurate and useful information from the predicted passenger information, such as, bus status, bus location congestion level on the buses, and passenger oriented Key Performance Index, such as, passenger weighted waiting time. Based on this passenger information, dispatchers can make better decisions and instructions.

### CROSS-REFERENCE TO RELATED APPLICATION

This application claims the benefit of priority to Chinese Patent Application No. 201410229206.1, filed May 28, 2014, the contents of which are incorporated herein by reference.

### TECHNICAL FIELD

The present invention is related to a method and a system for predicting a waiting passenger count for bus dispatching, and an evaluation method and system for a dispatching scheme of buses.

### BACKGROUND

Online dispatching plays an important role in bus operation system, since offline scheduling (static scheduling) based on predefined demand cannot meet various dynamic variations. Online dispatching includes, for example, bus departure timetable scheduling, bus speed controlling, or stop skip instruction. In general, dispatching is only based on bus status or predicted bus status. Passenger flow information is not considered when dispatching buses. Because the boarding/alighting time is unknown, the bus status can not be predicted accurately. For example, when the passenger count at a previous stop is much larger than usual such that boarding time is longer than usual, the actual arrival time when the bus arrives at the next stop can be later than the predicted arrival time. A case where at least two buses along the same bus line run together is referred to as “bus bunching”. Bus bunching causes the service to be unreliable, for example, some passengers will wait a longer time, and some buses will become overcrowded. One of the key reasons of bus bunching is an abnormal passenger load, because a large boarding count will increase the bus dwell time and cause delays. Bus bunching is helpful to meet passenger flow burst. For example, when a large-scale exhibition or sport match ends, there will be an abnormal increase in the passenger count at near stops. Therefore, the bus system, which serves the passengers, should be dispatched based on not only the bus status, but also the passenger flow information. This involves prediction of the passenger flow.

In the prior arts that perform the passenger flow prediction, there are nonparametric statistical methods, parametric methods and a real-time simulation method.

Nonparametric statistical methods include, e.g., neural network, SVM (Support Vector Machine), etc. Nonparametric statistical methods require environmental variables, such as date, time and weather as their input variables and find the relationship between the passenger flow and environmental conditions. However, a Waiting Passenger Count (“WPC”) strongly relates to the bus location, which is difficult to be modeled as an environmental condition.

Parametric methods include, e.g., linear regression, time series models, Kalman filtering techniques, etc. Some of these techniques predict the passenger flow in a year or in a N-day interval. Such prediction is too coarse for a bus dispatcher to make a timely decision. In the Kalman Filter, WPC(t+1)=WPC(t)+w(t), where WPC( ) denotes WPC, w( ) denotes Gaussian noise. It can be seen that this passenger flow prediction does not take into account the passenger demand and the bus location.

The real-time simulation method is based on real-time OD (“Origin-Destination”) estimation. The real-time simulation method requires solid data (e.g., historical OD matrix) and high-efficient computers to support real-time simulation. This results in a high cost for bus dispatching.

### SUMMARY

In view of the above, the present invention provides a method and a system for combining bus location prediction with passenger flow prediction, as well as an evaluation method and an evaluation system for a dispatching scheme of buses.

According to an aspect of the present invention, a method for predicting a WPC is provided. Bus stop arrival time is predicted based on historical travel data of buses and current bus travel data. Where the prediction of the next bus stop arrival time is considered, the WPC at the stop in the next time period is predicted based on historical passenger flow data and a current WPC.

According to another aspect of the present invention, an evaluation method for a dispatching scheme of buses is provided. Where the prediction of the next bus stop arrival time is considered, the WPC at the stop in the next time period is predicted based on historical passenger flow data and a current WPC. To determine whether the Key Performance Index (“KPI”) is smaller than a predetermined value to evaluate the dispatching scheme of buses, an integral of the product of the predicted WPC and their waiting time as KPI are used.

According to another aspect of the present invention, there is a system for predicting a WPC. Arrival time is predicted based on historical travel data of buses and current bus travel data. When buses arrive at a bus stop, a WPC is predicted based on historical passenger flow data and a current WPC. A WPC at the stop in the next time period is predicted, where the prediction result of the arrival time is considered.

According to another aspect of the present invention, there is provided an evaluation system for a dispatching scheme of buses. Arrival time is predicted based on historical travel data of buses and current bus travel data. When buses arrive at a bus stop, a WPC is predicted based on historical passenger flow data and a current WPC. A WPC at the stop in the next time period is predicted, where the prediction result of the arrival time is considered. A KPI setting device is configured to use an integral of the product of the predicted WPC and their waiting time as the KPI. To determine whether the KPI is smaller than a predetermined value, an evaluator is configured to evaluate a dispatching scheme of buses.

The WPC predicted according to the method and the system of the present invention is closer to the actual WPC and coincides with it. In addition, by setting a passenger oriented KPI with the WPC predicted according to the method and the system of the present invention, it is possible to reflect passengers' overall experience of the service of the bus system in a more real way. It is possible to improve the degree of passengers' satisfaction with the service of the bus system by using the KPI to make an evaluation on dispatching schemes and finding a dispatching scheme meeting the KPI based on the evaluation.

### BRIEF DESCRIPTION OF THE SEVERAL VIEWS OF THE DRAWINGS

Features and advantages of the present invention will become apparent, through description of embodiments of the present invention.

FIG. 1 shows an exemplary computer system/server which is applicable to implement the embodiments of the present invention.

FIG. 2 is an explanatory diagram for explaining an issue of bus bunching.

FIG. 3 is an explanatory diagram illustrating a case of passenger flow when bus bunching happens.

FIG. 4 is a flowchart illustrating a method for predicting a WPC according to an embodiment of the present invention.

FIG. 5 illustrates an example of predicted travel time of a journey.

FIG. 6 is a flowchart illustrating a process in a WPC prediction step according to an embodiment of the present invention.

FIG. 7 is a diagram illustrating obtaining an Arrival Passenger Count (“APC”) from a boarding count of historical passenger flow data according to an embodiment of the present invention.

FIG. 8 is a diagram illustrating an example of utilizing a seasonal ARIMA model to predict the APC.

FIG. 9 is a flowchart illustrating a process in a step of predicting a Departure Passenger Count (“DPC”) according to an embodiment of the present invention.

FIG. 10 illustrates a KPI set with the WPC predicted according to an embodiment of the present invention.

FIG. 11 is a flowchart illustrating an evaluation method for a dispatching scheme of buses according to an embodiment of the present invention.

FIG. 12 illustrates an effect of prediction of the WPC according to the present invention.

FIG. 13 is a block diagram illustrating a system for predicting a WPC according to an embodiment of the present invention.

FIG. 14 is a block diagram illustrating an evaluation system for a dispatching scheme of buses according to an embodiment of the present invention.

### DETAILED DESCRIPTION

Preferred embodiments will be described in detail with reference to the accompanying drawings, in which the embodiments of the present invention have been illustrated. The present invention can be implemented in various manners, and thus should not be construed to be limited to the embodiments illustrated herein.

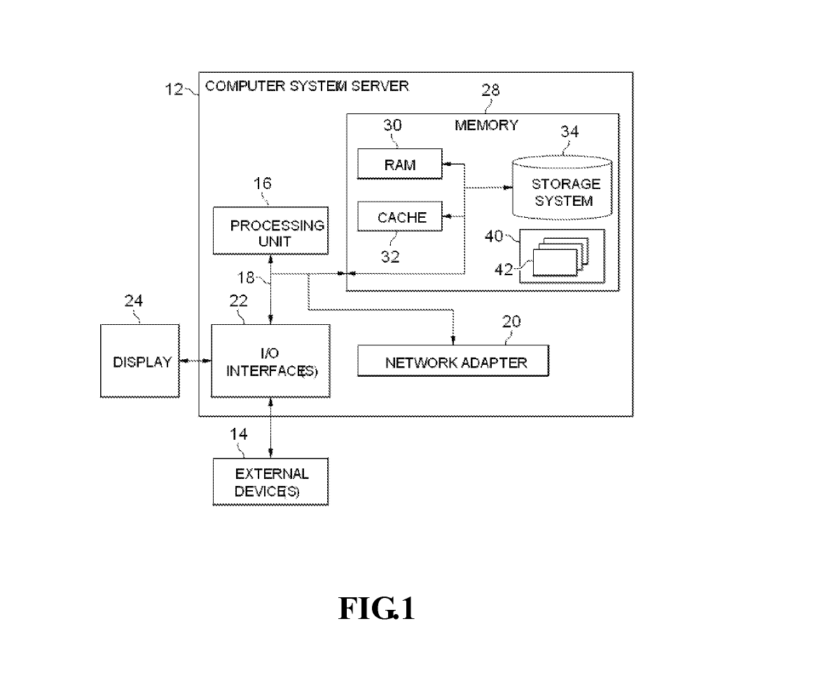

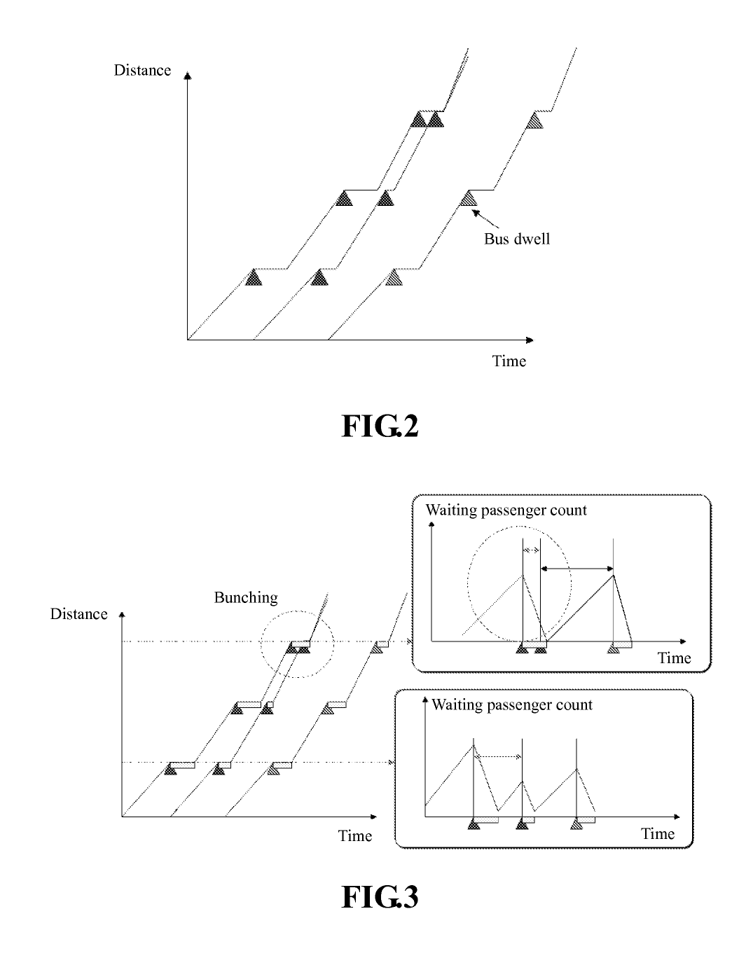

Referring to FIG. 1, in which an exemplary computer system/server 12 is shown. The components of computer system/server 12 includes, one or more processors or processing units 16, a system memory 28, and a bus 18 that couples various system components.

Bus 18 represents one or more types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media, which are accessible by computer system/server 12, and includes both volatile and non-volatile media, removable and non-removable media.

System memory 28 can include computer system readable media in the form of volatile memory, such as random access memory (RAM) 30 and/or cache memory 32. Computer system/server 12 includes other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 can include at least one program product having a set of program modules that are configured to carry out the functions of embodiments of the invention.

Program/utility 40, having a set of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24; one or more devices that enable a user to interact with computer system/server 12; and/or any devices (e.g., network card, modem) that enable computer system/server 12 to communicate with one or more other computing devices. Such communication can occur via Input/Output (I/O) interfaces 22. Further, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, device drivers, redundant processing units, external disk drive arrays, RAID systems, tape drives, and data archival storage systems.

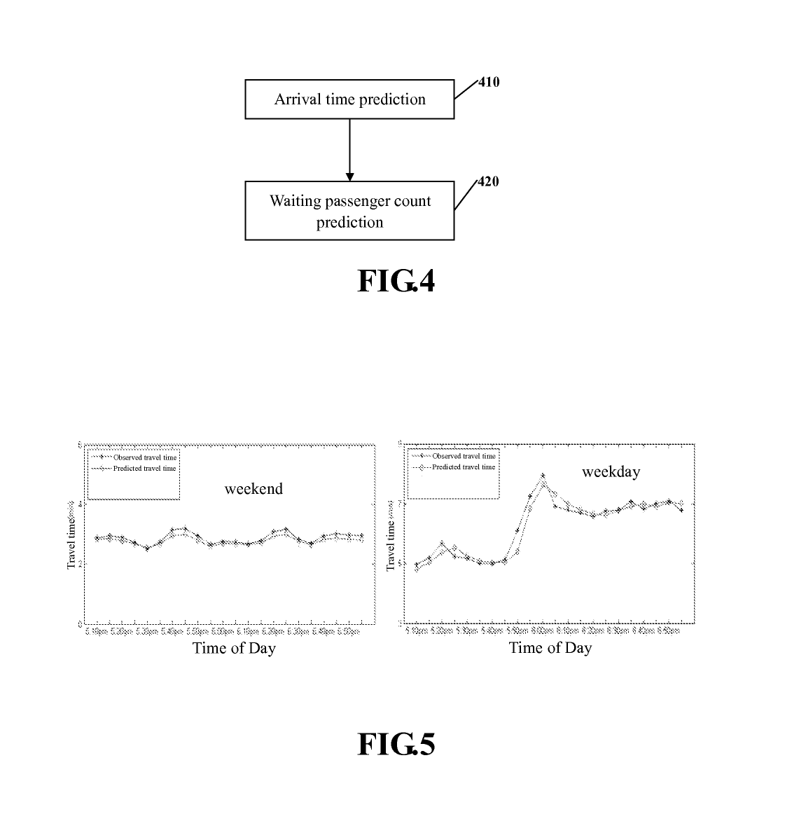

FIG. 4 is a flowchart illustrating a method 400 for predicting a WPC count according to an embodiment of the present invention. The method 400 includes an arrival time prediction step 410 and a WPC prediction step 420.

In the arrival time prediction step 410, arrival time when buses arrive at a bus stop is predicted based on historical travel data of buses and current bus travel data. Here, historical travel data includes at least one of speed, location of a bus corresponding to different time of a day in history. Current bus travel data includes at least one of current speed, location of a bus. In addition, the buses refer to buses along the same bus line. Current bus travel data can be obtained, for example, through Global Positioning System (GPS) or through other sensors (such as gyro or RFID) installed on the bus.

In an embodiment of the present invention, in step 410, historical travel data, such as speed, of buses is used to train a bus speed model through a statistical method or data mining. The error of the predicted bus speed is reduced based on current bus travel data, through a filtering method (e.g., Kalman Filtering).

The predicted travel time of a journey is based on the predicted bus speed in a future time period (e.g., 15 minutes, half an hour, etc). FIG. 5 illustrates an example of predicted travel time of a journey. In FIG. 5, the left part of FIG. 5 illustrates time taken to complete the journey when starting at different time of a day in the weekend, and the right part of FIG. 5 illustrates time taken to complete the journey when starting at different time of a day in the weekday. In FIG. 5, a line connecting solid points indicates observed travel time, and a line connecting hollow points indicates predicted travel time. In FIG. 5, the predicted travel time in the morning peak hours of the weekday is the longest.

Arrival time of the bus can be predicted with the predicted travel time and current location of the bus. For example, knowing current location of the bus and predicted travel time of traveling from current location to the next bus stop, the predicted arrival time can be obtained.

In “Bus Arrival Time Prediction Model Based On SVM And Kalman Filter” by Yu Bin, Yang Zhongzhen, Zeng Qingcheng, (China Journal of Highway and Transport, Vol. 2: pp. 89-92 (2008)), a bus arrival time prediction model is described in detail.

In step 420, where the prediction result of the arrival time is considered, the WPC at the stop in the next time period is predicted based on historical passenger flow data and the WPC.

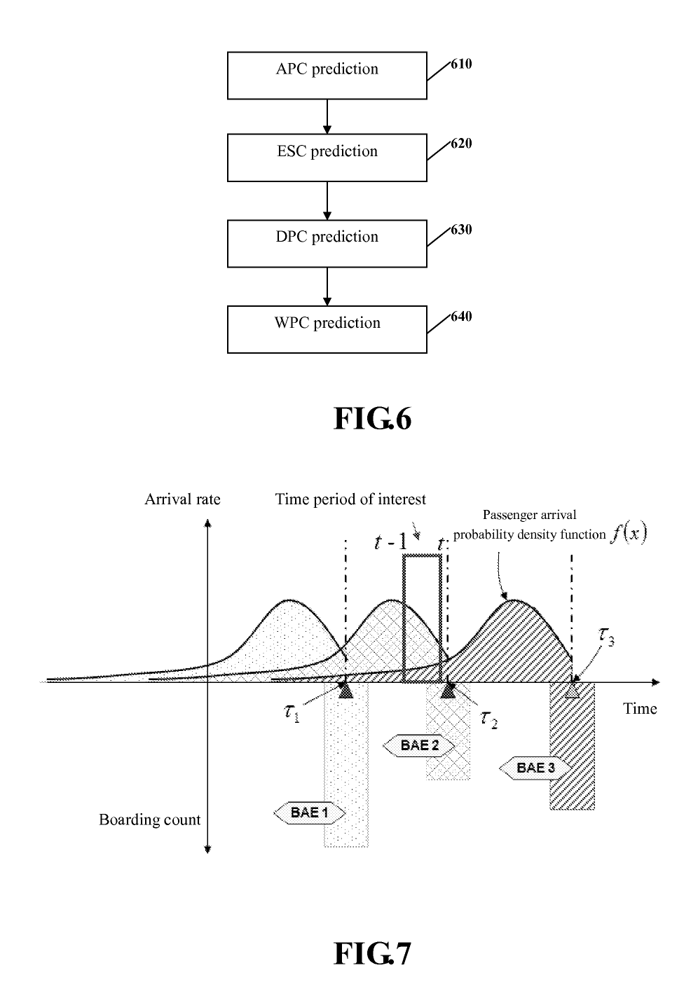

FIG. 6 is a flowchart illustrating a process 600 in a WPC prediction step according to an embodiment of the present invention. In the embodiment, the WPC prediction step includes: APC is performed (step 610) with respect to a bus stop based on historical passenger flow data. Also, the Empty Seat Count (“ESC”) of the bus is performed (step 620) based on historical passenger flow data. The prediction result of the APC, ESC, and DPC (step 630) is performed based on the prediction result of the arrival time. The WPC at the stop in the next time period is predicted (step 640) based on the APC, the DPC, and the current WPC.

Historical passenger flow data includes at least one of the boarding count and the ESC of a bus corresponding to different time of a day in history at respective stops. The current WPC is obtained through photographing and recognizing by a video camera at the stop. In an embodiment of the present invention, with a camera or video camera installed at the stop, through the pattern recognition technique, all the human objects within the stop or a demarcated area of the stop are counted so that the current WPC at the stop can be obtained. In an embodiment of the present invention, for a country where passengers are not allowed to stand on the bus, the ESC is the number of actual empty seats on the bus. In another embodiment of the present invention, for a country where passengers are allowed to stand on the bus, the ESC can be the number of passengers whom the bus can further accommodate estimated according to the photographed situation in the bus. In an embodiment of the present invention, the boarding count included in historical passenger flow data can be obtained by an automatic passenger counter installed on the bus, or obtained through photographing and recognizing by a video camera installed on the bus.

Although steps 610 and 620 in FIG. 6 are shown to be executed sequentially, those skilled in the art should understand that execution order of steps 610 and 620 can be inversed, or they can be executed in parallel. Hereinafter, processes in respective steps in the flowchart of FIG. 6 are described in detail.

In step 610, for a bus stop (e.g., bus stop X), with respect to every time period (e.g., 5-15 minutes), the APC is obtained from the boarding count included in historical passenger flow data. In an embodiment of the present invention, in prediction of the APC, passengers who board the same bus at the same bus stop are assumed to arrive at the bus stop according to a particular distribution, and arrival of each bus corresponds to a distribution, and the APC in a time period is equal to the sum of integrals of respective the distributions within the time period.

FIG. 7 is a diagram illustrating an APC from a boarding count of historical passenger flow data according to an embodiment of the present invention. As shown in FIG. 7, buses arrive at the bus stop X at time τᵢ, τ₂, τ₃ respectively, so that Bus Arrival Events (“BAE”) BAE1, BAE2 and BAE3 occur. Boarding counts in events BAE1, BAE2 and BAE3 correspond to the length of rectangles below the abscissa axis. Boarding passengers in the event BAE1 are assumed to arrive at the bus stop X according to a particular distribution (e.g., Poisson distribution), this distribution corresponds to a shape that is above the abscissa axis and has the same pattern (point-like pattern) as the rectangle of the boarding count in the BAE1 event. Similarly, arrival of boarding passengers in the BAE2 event corresponds to a distribution shape with a grid pattern, and arrival of boarding passengers in the BAE3 event corresponds to a distribution shape with a twill pattern.

For the time period of interest (t−1, t) in FIG. 7, the APC within that time period is equal to the sum of the areas of a portion of the distribution with the grid pattern (corresponding to BAE2) and a portion of the distribution with the twill pattern (corresponding to BAE3) falling within that time period. The following expression can be used to calculate the APC:

$$APC ( t ) = {\sum }_{i} ( {B}_{his} ( {τ}_{i} ) \times {\int }_{t - 1}^{t} f ( x ) d x ) , \\ i ∈ \{ i \vert {τ}_{i} > t - 1 \} ,$$

where APC(t) denotes the number of passengers arriving at the stop in the (t−1, t) time period, Bₕᵢₛ(τᵢ) denotes the boarding count of the i-th bus, τᵢ denotes arrival time of the i-th bus, f(x) denotes the probability density function of the APC, Bₕᵢₛ(τᵢ)×∫ₜ₋₁^{t}f(x)dx denotes the number of passengers who board the i-th bus and arrive at the bus stop in the (t−1, t) time period. By calculating the APC in a way according to the above mentioned embodiment, the APC can be made to be closer to the actual APC.

In another embodiment, another method can be employed to obtain APC(t) from Bₕᵢₛ(τᵢ). For example, for every two adjacent buses i−1 and i that arrive at the bus stop, it is assumed that arrival time of the bus i−1 is τᵢ₋₁, arrival time of the bus i is τᵢ, and the boarding count is Bₕᵢₛ(τᵢ). Then, the APC in unit time in the time period (τᵢ₋₁,τᵢ) can be calculated as

$$A ( {τ}_{i - 1} , {τ}_{i} ) = \frac{{B}_{his} ( {τ}_{i} )}{{τ}_{i} - {τ}_{i - 1}} .$$

In this case, if one wants to calculate the APC in a time period of length T, one first checks that the time period falls between arrival time of which two buses. If the time period falls between arrival time uᵢ₋₁ and uᵢ of two successive buses, the APC in the time period is APC(t)=T·A(uᵢ₋₁,uᵢ). In addition to above embodiments, those skilled in the art can think of other methods of obtaining APC(t) from Bₕᵢₛ(τᵢ).

After the APC is obtained, a seasonal time sequence (ARIMA) model is used to model historical APC to predict the APC of the current day. The seasonal ARIMA model is a modeling method proposed with respect to a time sequence with seasonal variations. It analyzes sequence values of the same time points in every season period, extracts the seasonal trend, and extracts non-seasonal components with respect to changes of sequence values within every season period, so as to establish an optimal model. In “Time Sequence Analysis Prediction And Control” by Geoge E. P. Box, translated by Gu Lan et al. (China Statistics Press, pp. 101-135 (1997)), the seasonal ARIMA model is introduced. In the application of the seasonal ARIMA model to the present invention, by analyzing historical data (i.e., the APC obtained as above), forming passenger flow data of the same time period of several days in history into time sequence points, extracting the seasonal trend, using the seasonal ARIMA model to complete analysis of the APC data pattern, and predicting the APC of the same time period of a certain future day.

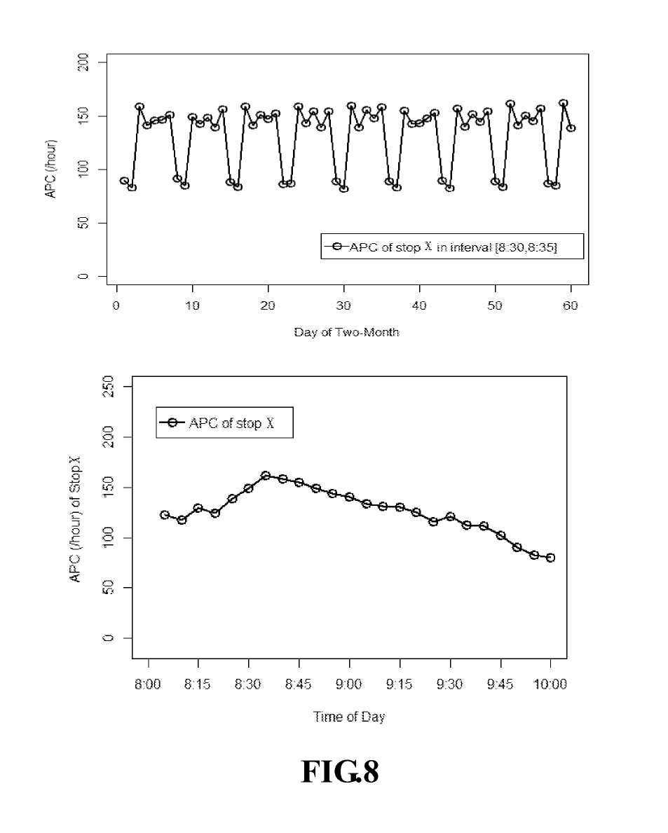

FIG. 8 is a diagram illustrating an example of utilizing a seasonal ARIMA model to predict the APC. The upper part of FIG. 8 illustrates historical data of the APC at the stop X within a 5 minute time period of [8:30, 8:35] over a time span of two months. The lower part of FIG. 8 illustrates APC of the current day predicted with the seasonal ARIMA model, wherein data of [8:30, 8:35] is predicted based on historical data of the upper part of FIG. 8. Thus, prediction of the APC is completed.

In step 620, prediction of an ESC of the bus is performed with respect to a bus stop (e.g., bus stop X) based on historical passenger flow data. Since historical passenger flow data directly includes the ESC of the bus at respective bus stops corresponding to different time of a day in history (that data can be acquired through a video camera installed on the bus), it is unlike the APC which needs to be derived from historical passenger flow data. Similar to the APC, the seasonal ARIMA model can be used to model historical ESC to predict ESC of the current day. Through prediction of the ESC of the bus, ESC of the current day (not shown) predicted with the seasonal ARIMA model can be obtained, which is similar to that shown in the lower part of FIG. 8. Thus, prediction of the ESC of the bus is completed.

In above examples, although prediction of the APC and prediction of the ESC of the bus is performed with the seasonal time sequence model, those skilled in the art can think of using other statistical methods or data mining methods to build a mathematic model so as to perform the prediction.

In step 630, prediction of the DPC is performed based on the prediction result of the arrival time, APC, and ESC.

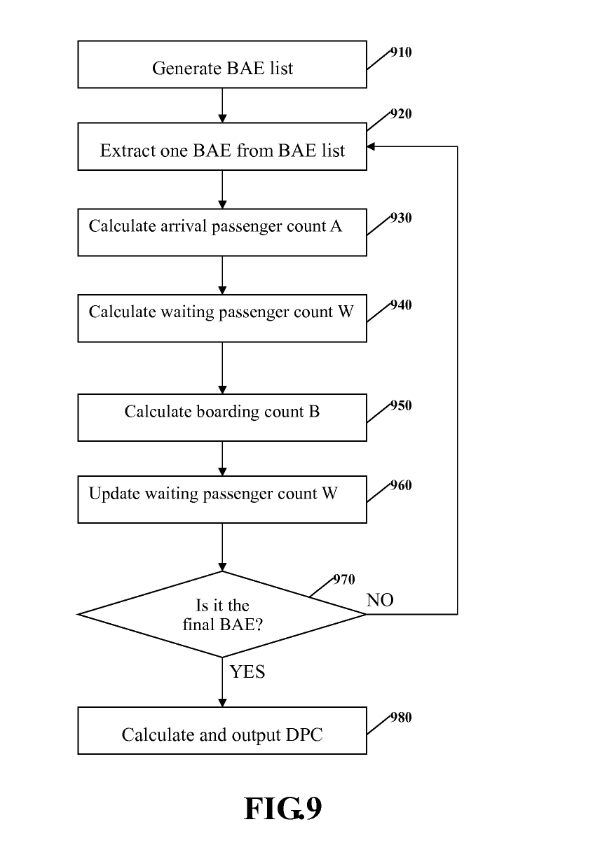

FIG. 9 is a flowchart illustrating a process 900 in a step of predicting a DPC according to an embodiment of the present invention. Hereinafter, an example of the process in step 630 is described with reference to FIG. 9. In this example, the DPC at the bus stop X during the time period (t−1, t) is predicted.

In step 910, a BAE list is generated based on arrival time predicted in the above mentioned step 410. In the BAE list, each BAE is a (b, s) pair where b denotes the ID of a bus, and s denotes predicted arrival time of the bus. Each BAE in the BAE list meets: time (t−1)<time s<time t.

In step 920, one BAE is extracted from the BAE list in order, and processes of steps 930 through 970 are performed with respect to the extracted BAE. It is assumed that the BAE extracted in this step is (BUS3, s).

In step 930, the number of passengers who arrive at the bus stop X within the time period (t−1, t) and before arrival time s of BUS3 is calculated as A=(time s-time (t−1))/(time t-time (t−1))×APC(t). Here, (time s-time (t−1)) denotes the time length from time t−1 to time s, (time t-time (t−1)) denotes length of the time period (t−1, t), and APC(t) denotes the APC at the bus stop X during the whole time period (t−1, t) predicted in step 610.

In step 940, the WPC before passengers board the bus BUS3 is calculated as W=W+A. Here, W is a variable, and “=” denotes assignment. In an embodiment of the present invention, before W is added to A, the value of W can be 0, which corresponds to a case where the (t−1, t) time period is the starting time period; or it can be predicted WPC at the end of the previous time period (t−2, t−1), which corresponds to a case where the (t−1, t) time period is not the starting time period. In another embodiment, before W is added to A, the value of W can be the WPC at the bus stop X at time t−1 photographed by the video camera at the bus stop.

In step 950, the number of passengers who board the bus BUS3 is calculated as B=min(W, ESC(t)). Here, min( ) means that the smaller value of the two is acquired, ESC(t) denotes the bus ESC corresponding to the stop X during the time period (t−1, t) predicted in the step 620. That is, when the current WPC is larger than the ESC (W>ESC(t)), only a part of waiting passengers can board the bus.

In step 960, the WPC is updated as W=W−B. The value of updated variable W denotes the remaining WPC after the bus BUS3 leaves. Here, “=” denotes assignment. The updated variable W can be used to calculate the WPC before passengers board the bus in step 940 with respect to the next BAE.

In step 970, it is judged whether the current BAE is the final BAE in the BAE list. If it is not the final BAE, the process returns to step 920 to extract the next BAE and perform operations of step 930 to step 970 with respect to the BAE. If it is the final BAE, the process proceeds to step 980.

In step 980, the boarding counts Bs calculated in step 950 in respective loops (one loop for each BAE) are added up so as to obtain predicted DPC. That is, DPC(t) is equal to the sum of the number of passengers who board respective buses at the stop X during the time period (t−1, t). Therefore, prediction of the DPC is completed.

Those skilled in the art can see that prediction of DPC is based on the BAE. In the present invention, prediction of arrival time is considered in the passenger flow prediction, i.e., prediction of arrival time is combined with the bus location prediction.

In another embodiment according to the present invention, step 620 can be omitted from the WPC prediction process shown in FIG. 6, i.e., prediction of the ESC of the bus is not performed. Accordingly, in step 630, prediction of the DPC is performed based only on the prediction result of the arrival time and the prediction result of the Count APC. Such prediction of the process shown in FIG. 9 can be adopted likewise. The difference is that, in step 950, the number of passengers who board a bus is calculated as B=W (i.e., the ESC of the bus is not considered). Also, in step 960, the WPC is updated as W=W−B=0. Other steps are the same as steps shown in FIG. 9. Thus, prediction of the DPC can be completed as well. This embodiment provides a simplified process for the WPC prediction shown in FIG. 6.

In an embodiment of the present invention, the process 600 as shown in FIG. 6 according to the present invention can further include calculating boarding time based on predicted boarding count and correcting arrival time when the bus arrives at the next stop according to boarding time. Since the boarding count of the bus BUS3 can be predicted, for example, in step 950 of FIG. 9, boarding time (i.e., dwell time) DTime=B×a can be obtained, where a denotes boarding time of one passenger and a is a constant. By providing dwell time DTime of BUS3 at the bus stop X, arrival time when BUS3 arrives at the next stop which is predicted in step 410 of FIG. 4 can be corrected. For example, if a large number of boarding passengers at the bus stop X results in the value of DTime being larger than a normal value, predicted time when BUS3 arrives at the stop X+1 is corrected to be delayed by an amount corresponding to DTime. In an embodiment of the present invention, the bus location prediction is also performed in conjunction with the passenger flow prediction, thereby rendering the predicted value to be closer to the actual value.

With reference back to FIG. 6, in step 640, based on the APC, the DPC and the current WPC, the WPC at the stop in the next time period is predicted.

In an embodiment of the present invention, Kalman filter is used to predict the WPC at the stop in the next time period. In “A New Approach to Linear Filtering and Prediction Problems” by Kalman, R. E. (Transactions of the ASME—Journal of Basic Engineering Vol. 82: pp. 35-45 (1960)), details of Kalman filter are introduced. Kalman filter is a highly efficient recursive filter (autoregression filter). It can estimate the state of the dynamic system from a series of incomplete and noise-containing measurements. Operations of Kalman filter include two phases: a prediction phase and an update phase. In the prediction phase, the filter uses the estimation of the previous state to estimate the current state. In the update phase, the filter uses an observed value of the current state to optimize the predicted value obtained in the prediction phase to obtain a more accurate new estimation value, and also update the error gain term within the system at the same time.

In step 640, the evolution equation in the Kalman filter is set as: WPC(t)=WPC(t−1)+u(t)+ω(t−1), where u(t)=APC(t)−DPC(t) is the state change equation of the WPC, ω(t−1) is the system error of the state change equation, and symbols t−1 and t denote terms corresponding to the previous time period and the current time period respectively. The observation equation in the Kalman filter is set as: y(t)=WPC (t)+υ(t−1), where y(t) is the observed value of WPC, and υ(t−1) is the error of the observed WPC.

In the prediction phase, the WPC of the previous time period (i.e., WPC(t−1)) and the state change equation u(t)=APC(t)−DPC(t) are used to estimate the WPC of the current time period (i.e., WPC(t)). In the update phase, the WPC observation value of the current time period (photographed and recognized by the video camera of the stop, i.e., y(t)) is used to optimize the WPC estimation value obtained in the prediction phase to obtain a more accurate estimation value and update the error gain. Prediction of the WPC at the stop in the next time period is iteratively performed, and the WPC in a future time period is predicted repeatedly. Thus, the WPC at a stop in the next time period is obtained.

In the above examples, the Kalman filter is used to predict the WPC at the stop in the next time period. In another embodiment according to the present invention, the Bayes filter can also be used to perform the prediction. The Bayes filter is a recursive filter based on probability density, which uses all known information to configure a posteriori probability density of the system state variable. In addition to the above filtering methods, those skilled in the art can also think of using other similar algorithms to perform such prediction.

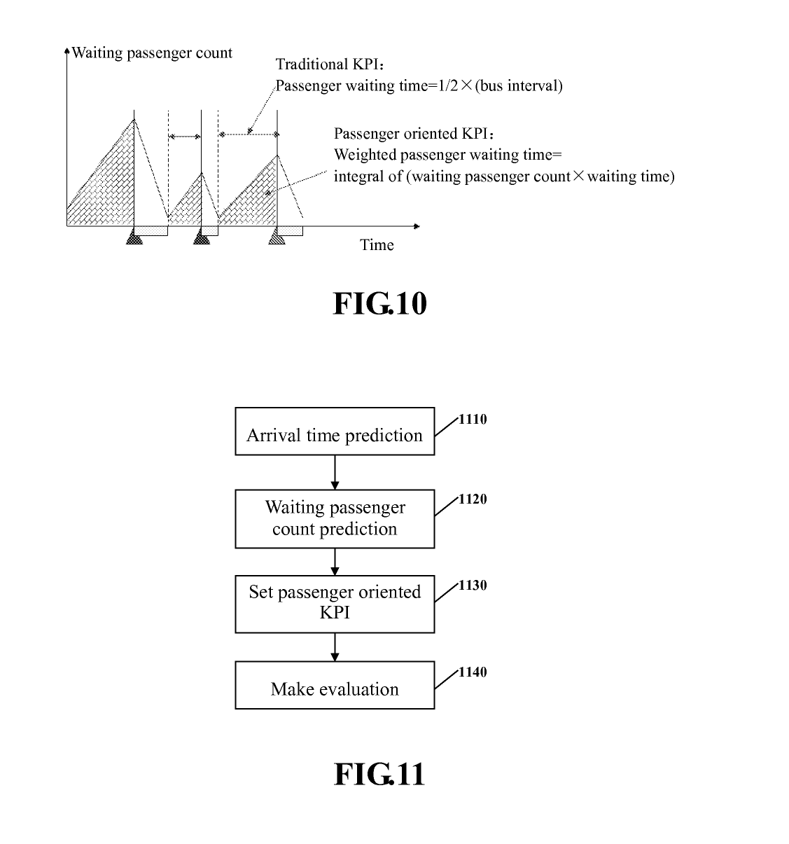

FIG. 10 illustrates a KPI set with the WPC predicted according to an embodiment of the present invention. In the prior art, the passenger waiting time is typically used as the KPI, and the passenger waiting time is simply considered to be equal to ½ of the bus interval. Such traditional KPI considers only operation of the bus, but not passengers. For example, a case where 100 passengers wait 10 minutes is different from a case where 5 passengers wait 10 minutes. It is necessary to reduce most passengers' waiting time as much as possible, thereby improving the overall experience of the service. In the present invention, there is proposed a passenger oriented KPI, i.e., weighted passenger waiting time. For example, an integral of the product of the WPC predicted in the method of FIG. 4 and their waiting time can be used as the KPI (see the brick pattern portion in FIG. 10). By using the method of the present invention, it is possible to obtain the WPC of each time period, thereby enabling the integral.

FIG. 11 is a flowchart illustrating an evaluation method 1100 for a dispatching scheme of buses according to an embodiment of the present invention. The evaluation method 1100 includes step 1110 to step 1140. Processes in step 1110 and step 1120 in FIG. 11 are the same as processes in step 410 and step 420 in FIG. 4.

In step 1130, an integral of the product of the predicted WPC and their waiting time is used as the KPI.

In step 1140, a dispatching scheme of buses is evaluated to determine whether the KPI is smaller than a predetermined value. For example, the dispatching scheme can include, but not limited to, the following means: notifying the driver of the bus to accelerate or decelerate, notifying the driver of the bus to skip a stop, increasing or decreasing the departure interval, or publishing passenger guide information at the stop. The bus dispatching performed after the KPI is set can employ various well known methods, which is not described in detail. For example, it is assumed that KPI=“weighted passenger waiting time is less than 45”. At this time, prediction is made based on the current dispatching scheme, and evaluation is made according to the predicted value. Based on the evaluation, if the obtained KPI≧45, the current dispatching scheme can be modified to generate a new dispatching scheme, and prediction and evaluation are made again based on the new dispatching scheme, until a dispatching scheme that meets KPI<45 is found.

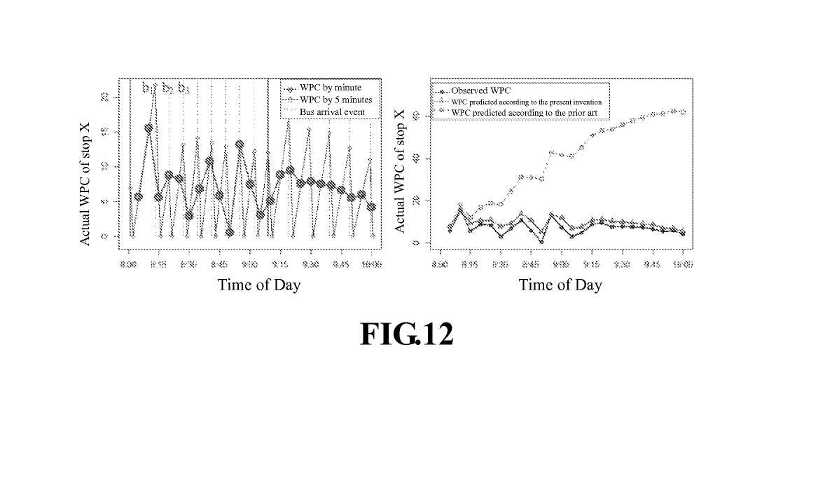

FIG. 12 illustrates an effect of prediction of the WPC according to the present invention. The left part of FIG. 12 illustrates the actual WPC at the stop X in the morning of a certain day, and the right part of FIG. 12 illustrates comparison of effects of the method according to the present invention and the method of the prior art (not considering the location of the bus). As can be seen from that figure, the WPC predicted according to the method of the present invention is closer to the actual WPC and coincides with it.

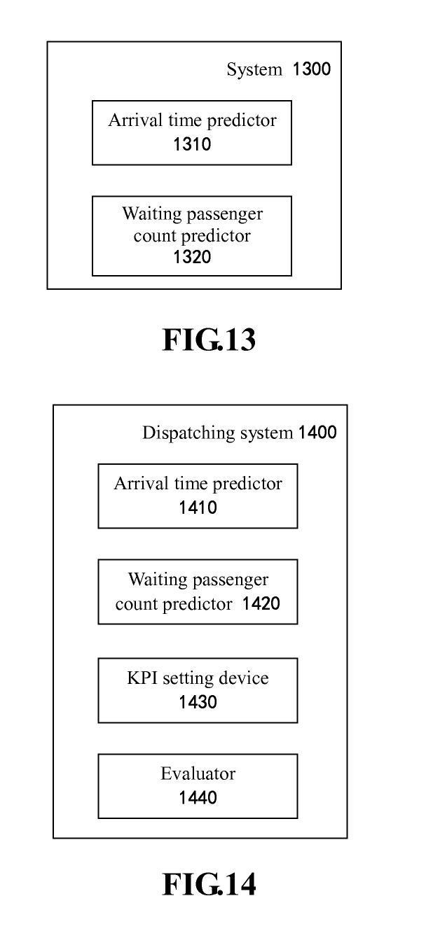

FIG. 13 is a block diagram illustrating a system 1300 for predicting a WPC count according to an embodiment of the present invention. The system 1300 includes an arrival time predictor 1310 and a WPC predictor 1320. The arrival time predictor 1310 is configured to predict the arrival time when buses arrive at a bus stop based on historical travel data of buses and current bus travel data. The WPC predictor 1320 is configured to predict the WPC count at the stop in the next time period, where the prediction result of the arrival time is considered based on historical passenger flow data and a WPC.

FIG. 14 is a block diagram illustrating an evaluation system 1400 for a dispatching scheme of buses according to an embodiment of the present invention. The evaluation system 1400 includes an arrival time predictor 1410, WPC predictor 1420, a KPI setting device 1430 and an evaluator 1440. The arrival time predictor 1410 is configured to predict arrival time when buses arrive at a bus stop based on historical travel data of buses and current bus travel data. The WPC predictor 1420 is configured to predict, where the prediction result of the arrival time is considered, the WPC at the stop in the next time period based on historical passenger flow data and a current WPC. The KPI setting device 1430 is configured to use an integral of the product of the predicted WPC and their waiting time as the KPI. To determine whether the KPI is smaller than a predetermined value, the evaluator 1440 is configured to evaluate a dispatching scheme of buses.

The present invention can be a system, a method, and/or a computer program product. The computer program product can include a computer readable storage medium or media having computer readable program instructions thereon for causing a processor to carry out aspects of the present invention.

The computer readable storage medium can be a tangible device that can retain and store instructions for use by an instruction execution device. The computer readable storage medium can, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scheme, the remote computer can connected to the user's computer through any type of network, including a local area network (LAN) or a wide area network (WAN), or the connection can made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various embodiments of the present invention have been presented for purposes of illustration, but are not intended to be exhaustive or limited to the embodiments illustrated herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments illustrated herein.

What is claimed is:

1. A method for predicting a waiting passenger count comprising:
based on historical travel data of buses and current bus travel data, predicting arrival time when buses arrive at a bus stop; and
based on historical passenger flow data and a current waiting passenger count, and in a case where the prediction result of said arrival time is considered, predicting a waiting passenger count at said stop in the next time period.

2. The method according to claim 1, wherein the historical travel data comprises at least one of speed, location of said bus corresponding to different time of a day in history.

3. The method according to claim 1, wherein the current bus travel data comprises at least one of current speed, location of said bus.

4. The method according to claim 1, wherein the historical passenger flow data comprises at least one of a boarding count and a empty seat count of said bus at said stop corresponding to different time of a day in history.

5. The method according to claim 1, wherein the current waiting passenger count is obtained through photographing and recognizing by a video camera at said stop.

6. The method according to claim 1, wherein predicting the waiting passenger count at said stop in the next time period comprising, with respect to said bus stop:
based on historical passenger flow data, performing prediction of an count;
based on historical passenger flow data, performing prediction of an empty seat count of said bus;
based on the prediction result of said arrival time, the prediction result of said arrival passenger count and the prediction result of said empty seat count, performing prediction of a departure passenger count; and
based on said arrival passenger count, said departure passenger count and the current waiting passenger count, predicting the waiting passenger count at said stop in the next time period.

7. The method according to claim 6, wherein prediction of the arrival passenger count and prediction of the empty seat count of said bus is performed with a seasonal time sequence model.

8. The method according to claim 6, wherein in prediction of the arrival passenger count, passengers who board the same bus at the same bus stop are assumed to arrive at the bus stop according to a particular distribution, and arrival of each bus corresponds to a distribution, and the arrival passenger count in a time period is equal to the sum of integrals of respective said distributions within the time period.

9. The method according to claim 6, further comprising calculating boarding time based on predicted departure passenger count and correcting arrival time when the bus arrives at the next stop according to the boarding time.

10. An evaluation method for a dispatching scheme of buses comprising:
based on historical travel data of buses and current bus travel data, predicting arrival time when buses arrive at a bus stop;
based on historical passenger flow data and a current waiting passenger count, and in a case where the prediction result of said arrival time is considered, predicting a waiting passenger count at said stop in the next time period;
using integral of the product of the predicted waiting passenger count and their waiting time as the Key Performance Index (“KPI”); and
evaluating the dispatching scheme of buses to determine whether said KPI is smaller than a predetermined value.

11. A system for predicting a waiting passenger count comprising:
an arrival time predictor configured to predict, based on historical travel data of buses and current bus travel data, arrival time when buses arrive at a bus stop; and
a waiting passenger count predictor configured to predict, based on historical passenger flow data and a current waiting passenger count, and in a case where the prediction result of said arrival time is considered, a waiting passenger count at said stop in the next time period.

12. The system according to claim 11, wherein the historical travel data comprises at least one of speed, location of said bus corresponding to different time of a day in history.

13. The system according to claim 11, wherein the current bus travel data comprises at least one of current speed, location of said bus.

14. The system according to claim 11, wherein the historical passenger flow data comprises at least one of a boarding count and a empty seat count of said bus at said stop corresponding to different time of a day in history.

15. The system according to claim 11, wherein the current waiting passenger count is obtained through photographing and recognizing by a video camera at said stop.

16. The system according to claim 11, wherein the waiting passenger count predictor is further configured to, with respect to said bus stop:
based on historical passenger flow data, performing prediction of an arrival passenger count;
based on historical passenger flow data, performing prediction of an empty seat count of said bus;
based on the prediction result of said arrival time, the prediction result of said arrival passenger count and the prediction result of said empty seat count, performing prediction of a departure passenger count; and
based on said arrival passenger count, said departure passenger count and the current waiting passenger count, predicting the waiting passenger count at said stop in the next time period.

17. The system according to claim 16, wherein prediction of the arrival passenger count and prediction of the empty seat count of said bus is performed with a seasonal time sequence model.

18. The system according to claim 16, wherein in prediction of the arrival passenger count, passengers who board the same bus at the same bus stop are assumed to arrive at the bus stop according to a particular distribution, and arrival of each bus corresponds to a distribution, and the arrival passenger count in a time period is equal to the sum of integrals of respective said distributions within the time period.

19. The system according to claim 16, wherein the waiting passenger count predictor is further configured to calculate boarding time based on predicted departure passenger count and correct arrival time when the bus arrives at the next stop according to the boarding time.

20. An evaluation system for a dispatching scheme of buses comprising:
an arrival time predictor configured to predict, based on historical travel data of buses and current bus travel data, arrival time when buses arrive at a bus stop;
a waiting passenger count predictor configured to predict, based on historical passenger flow data and a current waiting passenger count, and in a case where the prediction result of said arrival time is considered, a waiting passenger count at said stop in the next time period;
a KPI setting device configured to use integral of the product of the predicted waiting passenger count and their waiting time as the KPI; and
an evaluator configured to evaluate a dispatching scheme of buses to determine whether said KPI is smaller than a predetermined value.
